(19) United States
(12) Patent Application Publication
(10) Pub. No.: US 2019/0361703 A1
(43) Pub. Date: Nov. 28, 2019

(54) METHOD AND APPARATUS FOR RENAMING SOURCE OPERANDS OF INSTRUCTIONS

(71) Applicant: Dejan Spasov, Skopje (MK)

(72) Inventor: Dejan Spasov, Skopje (MK)

(21) Appl. No.: 16/537,633

(22) Filed: Aug. 12, 2019

Related U.S. Application Data
(60) Provisional application No. 62/856,749, filed on Jun. 4, 2019.

(51) Int. Cl. G06F 9/38; G06F 9/30

(52) U.S. Cl. CPC G06F 9/384; G06F 9/30138; G06F 9/30196; G06F 9/30101

(57) ABSTRACT

A renaming unit configured to rename source operands of instructions in a group of instructions. A RAT-like renaming register maintains architectural to physical register mappings from prior group of instructions. Physical registers from the renaming register propagate through a chain of update units (U) over bus lines. Bus lines comprise one bus line per architectural register. The chain of update units sequentially, in program order, inserts physical registers allocated to instructions in the group on bus lines that correspond to the destination operands. Source operands of an instruction may be renamed to physical registers after physical registers allocated to instructions older than said instruction are sequentially, in program order, inserted on the bus lines, but before physical registers allocated to said instruction and younger instructions are inserted on the bus lines. A source operand is renamed to a physical register on a bus line that corresponds to the source operand.

### RELATED APPLICATIONS

This application claims priority to U. S. Provisional Patent Application number 62/856,749 filed on Jun. 4, 2019.

### BACKGROUND

### Field of the Invention

The present invention relates to microprocessors, and more particularly, to efficiently perform register renaming.

### Description of the Related Art

A processor may include a renaming unit where source operands of instructions are renamed to physical registers. Source and destination operands are architectural registers, such that source operands of instructions consumers of a result are equal to a destination operand of an instruction producer of the result. The processor may include plurality of physical registers organized in one or more physical register files. For each instruction with destination operand the renaming unit may be configured to allocate a physical register. A source operand of an instruction may be renamed to a physical register most recently allocated to an instruction with destination operand equal to the source operand. Most recently allocated physical registers may be organized in a structure known as architectural to physical register mappings.

In one embodiment, architectural to physical register mappings may be stored in a register alias table (RAT). The RAT comprises plurality entries indexed with the architectural registers. Each entry is configured to store a physical register most recently allocated to an instruction with destination operand equal to the index of the entry. Source operands of an instruction are renamed to physical registers from the RAT at indexes provided by the source operands. After source operands of an instruction are renamed, physical register allocated to the instruction is stored in the RAT at index provided by the destination operand of the instruction. Reading from the RAT and writing to the RAT is performed sequentially, in program order of the instructions, which makes the renaming process prohibitively slow.

In another embodiment, the renaming unit may be configured to simultaneously rename source operands in a group of instructions. The RAT may be configured to store architectural to physical register mappings from prior groups of instructions. The renaming unit is configured to compare a source operand of an instruction with destination operands of older instructions in the group and to output physical register allocated to the youngest instruction with destination operand equal to the source operand. If no match is found, the renaming unit is configured to read the RAT and to output physical register at index identified with the source operand. For a group of n instructions, the RAT is read in parallel, at indexes provided by the source operands. The RAT may be implemented as multi-ported SRAM with 2n read ports and n write ports. Hardware complexity of the RAT increases quadratically with respect to the number of ports. The renaming unit may include n×(n−1) comparators to compare each source operand with destination operands of older instructions. Hence, die area, wiring complexity, and power consumption of the renaming unit depend quadratically on the size n of the group of instructions. In multithreaded microarchitectures, said hardware complexity may have to be multiplied with the number of threads. Reading the RAT and comparing source with destination operands is performed in parallel, for each source operand in the group, which makes the renaming process excessively complex.

### SUMMARY

Method and apparatus for renaming source operands in a group of instructions is contemplated. Hardware complexity of embodiments described herein depends linearly on the size of instruction group.

A physical register from a list of free physical registers is allocated to each instruction in the group with destination operand. Instructions' source and destination operands are architectural registers selected from a plurality of architectural registers. A RAT-like renaming register stores architectural to physical register mappings from prior groups of instructions. The renaming register comprises one field per architectural register, which is configured to store physical register allocated to a youngest instruction from a prior group of instructions with destination operand that corresponds to the field. Physical registers from the renaming register are inserted on bus lines comprising one bus line per architectural register. Physical registers allocated to instructions in the group are sequentially, in program order, inserted on the bus lines. A physical register allocated to an instruction in the group is inserted on a bus line that corresponds to the destination operand of the instruction.

Source operands of the oldest instruction in the group may be renamed to physical registers stored in the renaming register at fields that correspond to the source operands. Source operands of an instruction, other than the oldest, may be renamed to physical registers after physical registers allocated to instructions older than the instruction are sequentially, in program order, inserted on the bus lines, but before physical registers allocated to the instruction and younger instructions are inserted on the bus lines. A source operand is renamed to a physical register on a bus line that corresponds to the source operand.

### BRIEF DESCRIPTION OF THE DRAWINGS

FIG. 1 shows an embodiment of a processor core;

FIG. 2 shows an embodiment of a renaming unit;

FIG. 3 shows an embodiment of an update unit;

FIG. 4 shows a method for renaming source operands of an instruction;

FIG. 5 shows an embodiment of central processing unit in accordance with the embodiments of the present invention;

### DETAILED DESCRIPTION

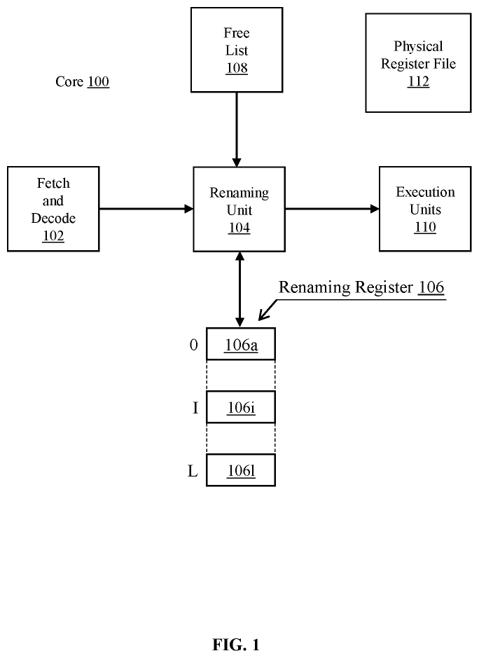

FIG. 1 shows microarchitecture of a core processor. The core 100 may include fetch and decode unit 102, renaming unit 104, renaming register 106, free list 108, execution units 110, physical register file 112, and other components and interfaces not shown on FIG. 1 to emphasize embodiments described herein. The core 100 may support multiple instruction issue, in-order or out-of-order execution, and multi-threading, wherein plurality of threads may simultaneously be processed, or plurality of threads may time-share the core 100, or combination thereof.

The fetch and decode unit 102 may be configured to fetch instructions from memory or cache and to output, in parallel, one or more decoded instructions or instruction (micro-)operations. The fetch and decode unit 102 may be configured to fetch instructions from any instruction set architecture, e.g. PowerPC™, ARM™, SPARC™, x86™, etc., and to output instructions that may be executed in the execution units 110. In other microarchitectures, the fetch and decode unit 102 unit may be represented with two or more units, e.g. fetch unit, decode unit, branch predictor, L1 cache, etc., not shown on FIG. 1 to emphasize embodiments described herein.

Instructions comprise source and destination operands. Source and destination operands are architectural registers selected from the plurality of architectural registers 0, 1, . . . , L, such that source operands of instructions consumers of a result are equal to a destination operand of an instruction producer of the result. The core 100 may include a plurality of physical registers organized in one or more physical register files 112. Physical registers of the core 100 may be configured to store speculative results and architecturally visible results. The free list 108 maintains a list of physical registers that may be allocated to instructions with destination operands. For each instruction with destination operand, the free list 108 is configured to allocate a physical register.

The fetch and decode unit 102 may be configured to output a group of instructions. The renaming unit 104 is configured to rename (map) source operands of instructions consumers of a result to the physical register allocated to the instruction producer of the result. A source operand of an instruction is renamed to physical register most recently allocated to an instruction with destination operand equal to the source operand. Most recently allocated physical registers may be organized in a structure known as architectural to physical register mappings. For an instruction, architectural to physical register mappings is a set of physical registers with one-to-one correspondence to the architectural registers, where a physical register that corresponds to an architectural register is allocated to the youngest instruction older than the instruction with destination operand equal to the architectural register. A source operand of an instruction may be renamed to a physical register from the architectural to physical register mappings for the instruction that corresponds to the source operand.

The renaming register 106 is configured to store physical registers comprising architectural to physical register mappings from prior groups of instructions. The renaming register 106 may include one field per architectural register 0, . . . , L 106a-1, where physical registers are stored. A physical register stored in a field I 106i is allocated to the youngest instruction from a prior group with destination operand equal to I. Content-wise the renaming register 106 is identical to the register alias table (RAT). However, RAT is operated as SRAM with a plurality of read ports and a plurality of (priority) write ports, while the renaming register 106 may be operated as SRAM with one read port and one write port. In a multi-threaded core 100, the renaming register 106 may include one field per architectural register per thread.

Physical registers from the renaming register 106 are inserted on a plurality of bus lines comprising one bus line per architectural register. A physical register allocated to an instruction in the group may be inserted on a bus line that corresponds to the destination operand of the instruction. Physical registers allocated to instructions in the group are inserted on the bus lines sequentially, in program order, of the instructions. The renaming unit 104 may be coupled to the renaming register 106 to store updated set of physical registers.

Source operands of the oldest instruction in the group may be renamed to physical registers stored in the renaming register 106 at fields that correspond to the source operands. Source operands of an instruction, other than the oldest, may be renamed to physical registers after physical registers allocated to instructions older than the instruction are sequentially, in program order, inserted on the bus lines, but before physical registers allocated to the instruction and younger instructions are inserted on the bus lines. A source operand may be renamed to a physical register on a bus line that corresponds to the source operand.

Execution units 110 may include any number and type of execution units, e.g. integer unit, floating point unit, load/store unit, branch unit, etc., configured to execute instructions. Instructions may be executed in-order or out-of-order. In out-of-order execution mode, the core 100 may include additional units to maintain in-order retirement of the instructions. One or more reservation stations may be included in the core 100 to host instructions waiting to be issued to the execution units 110.

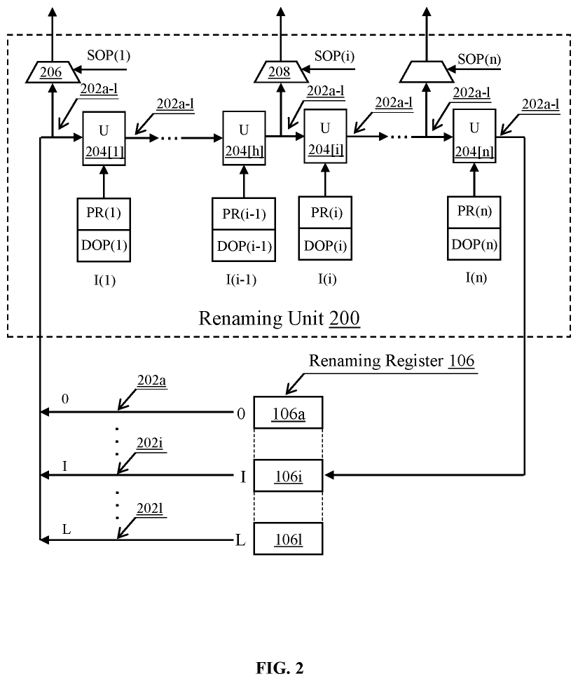

Referring now to FIG. 2, an embodiment of a renaming unit is shown. The renaming unit 200 is configured to rename source operands of instructions in a group of n instructions I(1), I(2), I(n). Each instruction I(i), i=1, 2, . . . , n, may include a source operand SOP(i), a destination operand DOP(i), and physical register PR(i), allocated to I(i). Instructions may be considered to be in program order, where each instruction I(i), i=1, 2, . . . , n−1, is older than its successor I(i+1).

The renaming unit 200 comprises a chain of n update units (U) 204[1]-[n]. Physical registers propagate from the renaming register 106 through the chain of update units 204[1]-[n] over bus lines denoted with 0, . . . , L 202a-1. A bus line I 202i may be considered to propagate physical register allocated to instruction with destination operand I. The first update unit 204[1], coupled to the renaming register 106, is configured to output PR(1) on a bus line denoted with DOP(1). A second update unit 204[2], coupled to the first update unit 204[1], is configured to output PR(2) on a bus line denoted with DOP(2), etc. The update unit 204[i], coupled to the preceding update unit 204[h], is configured to output PR(i) on a bus line denoted with DOP(i). The chain of update units 204[1]-[n] sequentially, in program order, outputs physical registers PR(1), PR(2), . . . , PR(n) allocated to instructions I(1), I(2), . . . , I(n) on bus lines 202a-1 denoted with DOP(1), DOP(2), . . . , DOP(n), respectively. The last update unit 204[n] may be coupled to the renaming register 106 to store physical registers for the next group of instructions.

In a multi-threaded core 100, update units 204[1]-[n] may be configured to output physical registers that are allocated to instructions from one thread. The renaming unit 200 may include one bus line per thread per architectural register, or one bus line per architectural register that may be time-shared by the plurality of threads. In one embodiment, the renaming unit 200 may include a plurality of chains as 204[1]-[n], wherein each chain may be configured to operate over instructions from one thread.

Source operands of the oldest instruction I(1) may be renamed to physical registers from the physical registers stored in the renaming register 106. A multiplexer 206 may be coupled to the renaming register 106. A source operand SOP(1) of the oldest instruction I(1) may be coupled as selection control to the multiplexer 206. The multiplexer 206 may be configured to output physical register from a field that corresponds to SOP(1); thus, renaming the source operand SOP(1) to a physical register.

Source operands of an instruction I(i), i=2, 3, . . . , n, may be renamed to physical registers after physical registers PR(1), PR(2), PR(i−1) allocated to instructions older than I(i) are inserted on the bus lines 202a-1, but before physical registers PR(i), PR(i+1), . . . , PR(n) allocated to I(i) and younger instructions are inserted on the bus lines 202a-1. The sub-chain of update units 204[1]-[h] sequentially, in program order, inserts physical registers PR(1), PR(2), PR(i−1) on the bus lines 202a-1. Hence, source operands of I(i) may be renamed to physical registers on the output of the update unit 204[h]. A multiplexer 208 may be coupled to the output of the update unit 204[h]. A source operand SOP(i) of I(i) may be coupled as selection control to the multiplexer 208. The multiplexer 208 may be configured to output physical register from a bus line that corresponds to SOP(i); thus, renaming the source operand SOP(i) to a physical register.

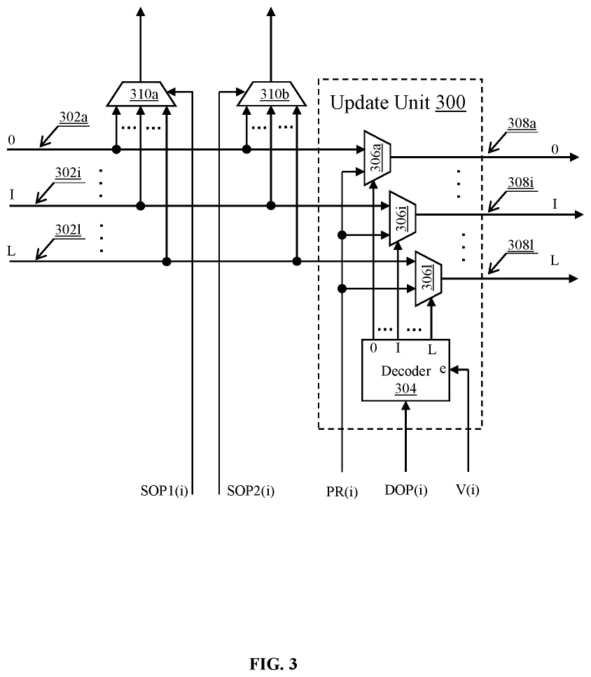

Turning now to FIG. 3, an embodiment of an update unit is shown. The update unit 300 is coupled to receive physical registers on the bus lines 0, . . . , L 302a-1. A bus line denoted with I 302i is coupled to provide physical register allocated to an instruction with destination operand I. The update unit 300 is coupled to receive allocated physical register PR(i), destination operand DOP(i), and a valid signal V(i) of an instruction I(i), i=1, 2, . . . , n. The valid signal V(i) indicates if I(i) is valid instruction with destination operand. In a multi-threaded core 100, the update unit 300 may be configured to rename instructions that belong to one thread in a group of instructions. Instructions from other threads may be considered invalid instructions. If V(i) indicates invalid instruction, the update unit 300 is configured to output received physical registers on the bus lines 0, . . . , L 308a-1. If V(i) indicates that I(i) is valid instruction with destination operand, the update unit 300 is configured output PR(i) on a bus line denoted with DOP(i), while remaining bus lines 308a-1 output physical registers received from the corresponding bus lines 302a-1.

The update unit 300 comprises a decoder 304 and plurality 2-to-1 multiplexers 306a-1. Those of ordinary skill in the art will appreciate that the hardware may vary depending on the implementation. Each multiplexer 306a-1 is coupled to receive PR(i) and one of the bus lines 302a-1. The decoder 304 is coupled to receive DOP(i) on the input and V(i) on the enable input. Output signal lines from the decoder 304, denoted with 0, . . . , L, are coupled as selection control to the multiplexers 306a-1. An output signal line I may be coupled as selection control to a multiplexer 306i, which is coupled to a bus line I 302i. The decoder 304 is configured to assert the output signal line I if DOP(i)=I and if V(i) indicates that I(i) is valid instruction with destination operand. If the output signal line I is asserted, the multiplexer 306i is configured to output PR(i) on the bus line I 308i. If the output signal line I is deasserted, the multiplexer 306i is configured to output physical register received on the bus line I 302i.

Multiplexers 310a-b may be coupled to the bus lines 302a-1 to rename source operands SOP1(i) and SOP2(i) of the instruction I(i). Source operands SOP1(i) and SOP2(i) are coupled as selection control to the multiplexers 310a-b. Multiplexers 310a-b are configured to output physical registers from the bus lines 302a-1 identified with SOP1(i) and SOP2(i), respectively. Thus, source operands SOP1(i) and SOP2(i) are renamed to physical registers.

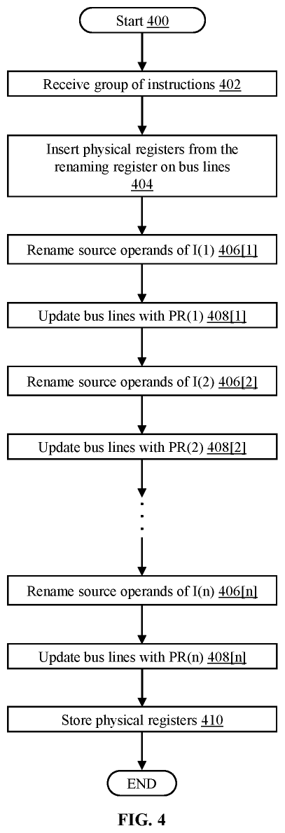

Turning now to FIG. 4, a method for renaming source operands is shown. A group of instructions is received for renaming (block 402). Each instruction may include one or more source operands, destination operand, and physical register allocated to the instruction. A renaming register comprises one field per architectural register, which stores physical register allocated to instruction with destination operand that corresponds to the field. Physical registers from the renaming register are inserted on a plurality of bus lines (block 404), comprising one bus line per architectural register.

Source operands of the oldest instruction in the group are renamed to physical registers from the fields of the renaming register that correspond to the source operands (block 406[1]). If the oldest instruction includes destination operand, physical register allocated to the instruction is inserted on a bus line that corresponds to the destination operand of the instruction (block 408[1]).

Source operands of the successor of the oldest instruction in the group are renamed to physical registers on bus lines that correspond to the source operands (block 406[2]). If the successor of the oldest instruction includes destination operand, physical register allocated to the instruction is inserted on a bus line that corresponds to the destination operand of the instruction (block 408[2]).

Blocks 406 and 408 are repeated for each instruction in the group, sequentially, in program order of the instructions, starting from the oldest instruction.

Source operands of the youngest instruction in the group are renamed to physical registers on bus lines that correspond to the source operands (block 406[n]). If the youngest instruction includes destination operand, physical register allocated to the instruction is inserted on a bus line that corresponds to the destination operand of the instruction (block 408[n]). Physical registers that propagate on the bus lines may be stored in the renaming register (block 410).

In a multi-threaded core 100, the renaming register may include one field per thread per architectural register, which stores physical register allocated to instruction from prior group with thread and destination operand that correspond to the field. Physical registers from the renaming register are inserted on a plurality of bus lines (block 404). The plurality of bus lines may comprise one bus line per thread per architectural register, or one bus line per architectural register that is time-shared by the plurality of threads. A source operand of an instruction from a thread is renamed to a physical register on a bus line that corresponds to the thread and the source operands (block 406). If the instruction includes destination operand, physical register allocated to the instruction is inserted on a bus line that corresponds to the thread and to the destination operand of the instruction (block 408). After physical registers allocated to instructions in the group are inserted on the bus lines, physical registers that propagate on the bus lines may be stored in the renaming register (block 410).

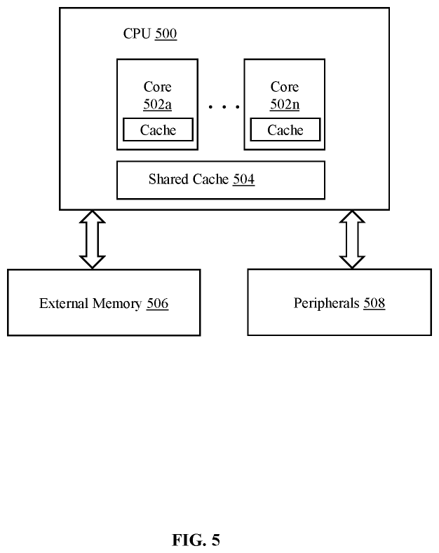

Referring now to FIG. 5, an embodiment of a central processing unit in accordance with the embodiments of the present invention is shown. It should be obvious to those skilled in the art that the central processing unit (CPU) 500 may be embodied as a hardware, software, combination of hardware and software, or computer program product, stored on a non-transitory storage media and later used to fabricate hardware comprising the embodiments described herein. The central processing unit 500 may be part of a desktop computer, server, laptop computer, tablet computer, cell or mobile phone, wearable device, special purpose computer, etc. The central processing unit 500 may be included within a system on a chip or integrated circuit, coupled to external memory 506 and peripheral units 508. The CPU 500 may include one or more instances of core processors 502a-n, shared cache 504, interface units, power supply unit, etc. At least one of the core processors 502a-n may include the embodiments described herein. External memory 506 may be any type of memory, such as dynamic random-access memory (DRAM), static random-access memory (SRAM), etc. In some systems, more than one instance of central processing units 500 and/or external memory 508 may be used on one or more integrated circuits. The peripheral unit 508 may include various types of communication interfaces, display, keyboard, etc.

I claim:

1. A processor comprising:
a plurality of architectural registers;
a plurality of physical registers;
a fetch and decode unit configured to output a group of instructions, wherein instructions comprise source and destination operands, wherein source and destination operands are identified with architectural registers, wherein a first instruction represents an oldest, in program order, instruction in the group, wherein a second instruction represents a successor, in program order, instruction of the first instruction, wherein a third instruction represents a successor, in program order, instruction of the second instruction, etc.;
a free list configured to allocate physical register to each instruction with destination operand;
a renaming register comprising one field per architectural register, wherein each field stores physical register allocated to a youngest instruction from prior group of instructions with destination operand that corresponds to the field;
one or more multiplexers coupled to the renaming register, wherein source operands of the first instruction are coupled as selection control to the multiplexers, wherein each multiplexer is configured to output physical register from a field that corresponds to a source operand of the first instruction coupled as selection control.

2. The processor in claim 1 comprising
a plurality of circuits coupled as a chain, wherein a first circuit in the chain is coupled to the renaming register to receive physical registers stored in the renaming register, wherein a second circuit in the chain is coupled to the first circuit to receive physical registers, wherein a third circuit in the chain is coupled to the second circuit to receive physical registers, etc., wherein circuits are coupled with bus lines, wherein bus lines comprise one bus per architectural register, wherein each bus line propagates physical register allocated to instruction with destination operand that corresponds to the bus line, wherein the first circuit in the chain is coupled to receive destination operand and physical register allocated to the first instruction, wherein the second circuit in the chain is coupled to receive destination operand and physical register allocated to the second instruction, wherein the third circuit in the chain is coupled to receive destination operand and physical register allocated to the third instruction, etc., wherein a last circuit in the chain is coupled receive destination operand and physical register allocated to a youngest instruction in the group.

3. The processor in claim 2 wherein a circuit is coupled to receive a destination operand and a physical register allocated to an instruction, wherein if said instruction is not valid instruction with destination operand the circuit is configured to output received physical registers, wherein if said instruction is valid instruction with destination operand the circuit is configured to output said physical register allocated to the instruction on a bus line that corresponds to said destination operand, wherein on remaining bus lines the circuit is configured to output received physical registers.

4. The processor in claim 3, wherein the circuit comprises a decoder and a plurality of 2-to-1 multiplexers, wherein each 2-to-1 multiplexer is coupled to a bus line, wherein each 2-to-1 multiplexer is coupled to said physical register allocated to the instruction, wherein the decoder is coupled to receive said destination operand of the instruction and a valid signal that indicates if the instruction is valid instruction with destination operand, wherein output signal lines of the decoder correspond to the architectural registers, wherein if said instruction is valid instruction with destination operand the decoder is configured to assert a signal line that corresponds to the destination operand, wherein a 2-to-1 multiplexer is coupled to receive the signal line as selection control, wherein the 2-to-1 multiplexer is coupled to a bus line that corresponds to the destination operand, wherein if the signal line is asserted the 2-to-1 multiplexer is configured to output the physical register allocated to the instruction, wherein if the signal line is not asserted the 2-to-1 multiplexer is configured to output physical register received on the bus line.

5. The processor in claim 4, wherein a register is coupled to the output of the last circuit to store outputted physical registers.

6. The processor in claim 5, wherein said register is the renaming register.

7. The processor in claim 5 comprising plurality of multiplexers coupled to output of each circuit except the last circuit, wherein source operands of the second instruction are coupled as selection control to multiplexers coupled to output of the first circuit, wherein source operands of the third instruction are coupled as selection control to multiplexers coupled to output of the second circuit, etc., wherein each multiplexer is configured to output physical register from a bus line that corresponds to the coupled source operand.

8. The processor in claim 5 configured to execute instructions from plurality of threads, wherein the renaming register comprises one field per thread per architectural register.

9. The processor in claim 8 wherein circuits in the chain are configured to identify instructions that belong to one thread as valid instructions.

10. The processor in claim 9 comprising a plurality of chains, wherein instructions that belong to one thread are recognized as valid instructions by circuits in one chain.

11. A method for renaming source operands of instructions in a group, the method comprising the steps
maintaining physical registers allocated to instructions from prior group in a renaming register, wherein the renaming register comprise one field per architectural register to store one physical register;
inserting said physical registers on bus lines, wherein bus lines comprise one bus line per architectural register, wherein a bus line that corresponds to an architectural register propagates physical register from a field that corresponds to the architectural register;
renaming source operands of an oldest instruction in the group, wherein a source operand of the oldest instruction is renamed to a physical register from a field that corresponds to the source operand.

12. The method in claim 11 further comprising
if the oldest instruction in the group is instruction with destination operand,
inserting a physical register allocated to the oldest instruction on a bus line that corresponds to a destination operand of the oldest instruction.

13. The method in claim 12 further comprising
for each instruction in the group, except the oldest instruction, sequentially, in program order of the instructions
renaming source operands of the instruction, wherein a source operand of the instruction is renamed to a physical register from a bus line that corresponds to the source operand;
if the instruction is instruction with destination operand,
inserting a physical register allocated to the instruction on a bus line that corresponds to a destination operand of the instruction.

14. The method in claim 13 further comprising
storing physical registers that propagate on the bus lines in a register.

15. The method in claim 14, wherein said register is the renaming register.

16. The method in claim 15, wherein instructions in the group belong to one or more threads, wherein the renaming register further comprises one field per thread per architectural register, wherein a source operand of an instruction from a thread is renamed to physical register from a bus line that corresponds to the thread and to the source operand, wherein a destination operand of the instruction is inserted on a bus line that corresponds to the thread and to the destination operand.

17. A method for maintaining physical registers in a renaming register comprising one field per architectural register, the method comprising the steps
receiving a group of instructions, wherein instructions comprise source and destination operands, wherein source and destination operands are architectural registers from the plurality of architectural registers;
inserting physical registers from the renaming register on bus lines comprising one bus line per architectural register;
for each instruction with destination operand, sequentially, in program order of the instructions in the group
inserting a physical register allocated to said instruction on a bus line that corresponds to the destination operand of said instruction.

18. The method in claim 17 further comprising
storing physical registers that propagate on the bus lines in a register.

19. The method in claim 18, wherein said register is the renaming register.

20. The method in claim 19, wherein instructions in the group may belong to one or more threads, wherein the renaming register further comprises one field per thread per architectural register, wherein a destination operand of an instruction from a thread is inserted on a bus line that corresponds to the thread and to the destination operand.
